(19) United States
(12) Patent Application Publication
(10) Pub. No.: US 2025/0194762 A1
(43) Pub. Date: Jun. 19, 2025

(54) PORTABLE UMBRELLA STAND

(71) Applicant: Michael C. STEWART, Sanford, FL (US)

(72) Inventor: Michael C. STEWART, Sanford, FL (US)

(21) Appl. No.: 18/987,511

(22) Filed: Dec. 19, 2024

Related U.S. Application Data
(60) Provisional application No. 63/611,857, filed on Dec. 19, 2023.

(51) Int. Cl. A45B 11/00; A45B 23/00; E04H 12/22; F16M 11/04; F16M 11/06; F16M 11/28

(52) U.S. Cl. CPC A45B 11/00; E04H 12/2223; F16M 11/041; F16M 11/06; F16M 11/28; A45B 23/00; A45B 2023/0012

(57) ABSTRACT

A portable umbrella stand includes a base having a plurality of slots, a plurality of extensions slidingly engaged with the plurality of slots and configured to be deployed outwards beyond a perimeter of the base, and a plurality of threaded anchors removably coupled to the base. The stand also includes a stanchion where a lower end is coupled to the base and an upper end extends away from the base. In addition, the stand includes a telescoping member having a lower end removably coupled to the upper end of the stanchion. An adjustable clamp is secured to the upper end of the telescoping member, where the adjustable clamp has a rotatable coupling configured to rotate relative to the telescoping member. The adjustable clamp comprises a bracket secured to the rotatable coupling and the bracket has a pair of opposing jaws extending therefrom that are configured to grasp an umbrella shaft.

### CROSS-REFERENCE TO RELATED APPLICATION

This application claims the benefit of U.S. Provisional Patent Application Ser. No. 63/611,857, filed Dec. 19, 2023, the contents of which are incorporated by reference herein.

### FIELD

The present invention relates to the field of shade umbrellas, and, more particularly, to a portable umbrella stand.

### BACKGROUND

An umbrella stand is a practical accessory designed to anchor and support umbrellas in sandy or soft soil conditions. Its intended to prevent umbrellas from being easily knocked over by wind while providing shade and shelter. Umbrella stands are typically made of durable materials like metal or plastic and are often lightweight and portable for transportation. They come in various designs, ranging from simple spikes to more complex systems that offer additional stability. Overall, a beach umbrella stand enhances the beach experience by keeping umbrellas securely in place, allowing people to relax comfortably under the shade.

However, there is a need for an umbrella stand that can be used both in soft soil conditions and also on hard surfaces. In addition, there is a need for an umbrella stand that can provide as much or more stability as much larger and heavier stands but without sacrificing being lightweight and portable.

### SUMMARY

In view of the foregoing background, it is therefore an object of the present invention to provide a portable umbrella stand that can be used on a wide variety of surfaces, is fully adjustable, lightweight and portable. Accordingly, a portable umbrella stand is disclosed and includes a base having a plurality of slots spaced apart on the base, a plurality of extensions slidingly engaged with the plurality of slots and configured to be deployed outwards along the plurality of slots beyond a perimeter of the base, and a plurality of threaded anchors removably coupled to the base. The plurality of extensions may increase in width from an interior portion to an outer portion to increase stability of the base when the plurality of extensions are deployed.

The stand also includes a stanchion having a lower end and an upper end, where the lower end is coupled to the base and the upper end extends away from the base. In addition, the stand includes a telescoping member having a lower end and an upper end, where the lower end is removably coupled to the upper end of the stanchion, and an adjustable clamp is secured to the upper end of the telescoping member. The telescoping member may include a plurality of elongated extensions.

The adjustable clamp has a rotatable coupling that is configured to rotate relative to the telescoping member, and a bracket that is secured to the rotatable coupling. The bracket has a pair of opposing jaws extending therefrom and the opposing jaws are configured to grasp an umbrella shaft. The pair of opposing jaws may be spring-loaded and biased in an open position. The bracket includes a rotatable handle that is secured to a pin passing through the pair of opposing jaws and the pair of jaws are configured to move between a closed position and the open position.

Each of the threaded anchors of the plurality of threaded anchors comprises external threading configured to cooperate with a plurality of apertures within the base so that rotating a respective threaded anchor in a first direction causes the respective threaded anchor to move downward relative to the base, and rotating the respective threaded anchor in an opposing second direction causes the respective threaded anchor to move upward relative to the base.

In another aspect, a portable umbrella stand is disclosed that includes a bracket having a pair of opposing jaws extending from a proximal end and configured to grasp an independent support. A first rotatable coupling is secured to a distal end of the bracket and configured to rotate about a first axis, and a second rotatable coupling is secured to the first rotatable coupling and configured to rotate about a second axis perpendicular to the first axis. The stand also included a receiver extending from the second rotatable coupling and configured to receive a shaft of an umbrella. In particular, the receiver defines a cavity for receiving the shaft of the umbrella. The bracket may include a rotatable handle secured to a pin passing through the pair of opposing jaws and the handle is configured to move the pair of opposing jaws between a closed position and the open position. The pair of opposing jaws are spring-loaded and biased in an open position. An extension may be inserted into the receiver for the shaft of the umbrella to slide over, and the extension may be threaded.

In another aspect, a method of securing an umbrella to the portable umbrella stand described above is disclosed. The method includes deploying the plurality of extensions outwards along the plurality of slots beyond a perimeter of the base, and securing a shaft of an umbrella in the adjustable clamp. The method includes using the adjustable clamp having a pair of opposing jaws to grasp the shaft of the umbrella. In addition, the method includes rotating the plurality of threaded anchors extending from the base to cause the plurality of threaded anchors to move downward relative to the base to secure the base to a ground surface.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of a portable umbrella stand in which various aspects of the disclosure may be implemented;

FIG. 2 is a top perspective view of a base and stanchion of the portable umbrella stand of FIG. 1;

FIG. 3 is a bottom perspective view of the base;

FIG. 4 is perspective view of an adjustable clamp of the portable umbrella stand;

FIG. 5 is a top perspective view of the adjustable clamp;

FIG. 6 is a rear perspective view of the adjustable clamp;

FIG. 7 is a partial cut-away perspective view of the adjustable clamp;

FIG. 8 is a top perspective view of a portable umbrella stand without a base;

FIG. 9 is a side view of the portable umbrella stand of FIG. 8; and

FIG. 10 is a perspective view of the portable umbrella stand without a base of FIG. 8.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

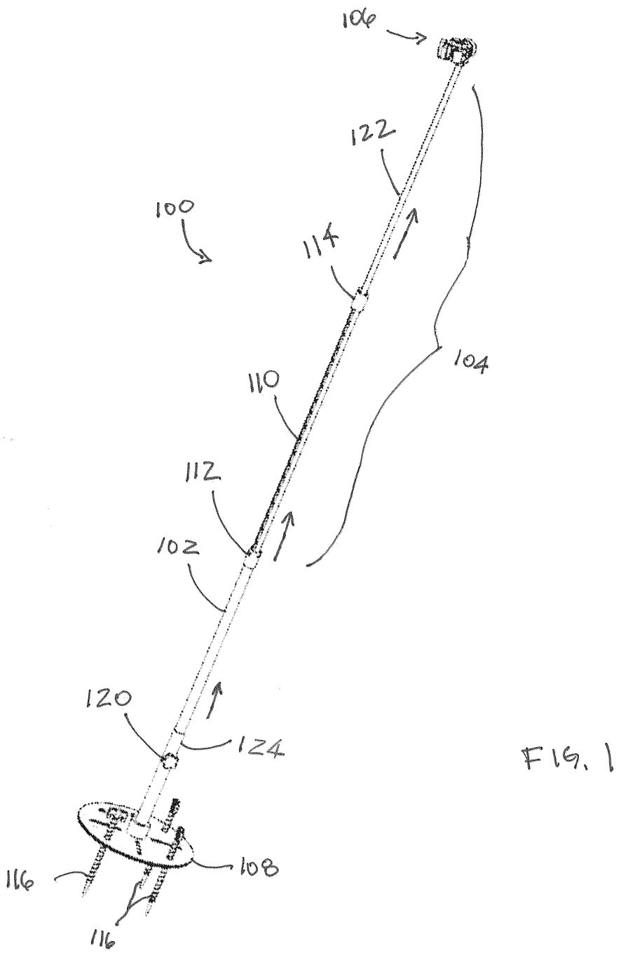

Referring now to FIG. 1, a portable umbrella stand is depicted and generally designated 100. The portable umbrella stand 100 includes a base 108 having a plurality of slots 105 spaced around the base 108. The slots 105 may be equally spaced about the base 108. A plurality of extensions 118 are slidingly engaged with the plurality of slots 105 and configured to be extended outwards beyond a perimeter of the base 108 to provide stability to the base 108.

The base 108 also includes a plurality of threaded anchors 116 that may be removably coupled to the base 108 and extending in a first downward direction away from the base 108. The threaded anchors 116 are configured to be inserted into a ground surface by rotating in order to provide stability to the base 108. As those of ordinary skill in the art can appreciate, there may be variable number of anchors 116 but preferably four.

The portable umbrella stand 100 includes a stanchion 102 that has a lower end and an upper end. The lower end of the stanchion 102 is removably inserted into a base receptacle 124 and the upper end of the stanchion 102 extends away from the base in a second upward direction opposite the first downward direction. A set screw 120 or other mechanical device may be used to secure the stanchion 120 within the base receptacle 124. The base 108 may be comprised of a relatively heavy material such as steel to provide additional stability, or comprised of lightweight plastic material that is easier to transport.

The portable umbrella stand 100 also includes a telescoping member 104 that has a lower end secured to the stanchion 102. The telescoping member 104 has a plurality of elongated extensions 110, 122 that can be extended to adjust a height of the adjustable clamp 106 discussed below. Clamps 112, 114 are used to secure the elongated extensions 110, 122 at the desired height.

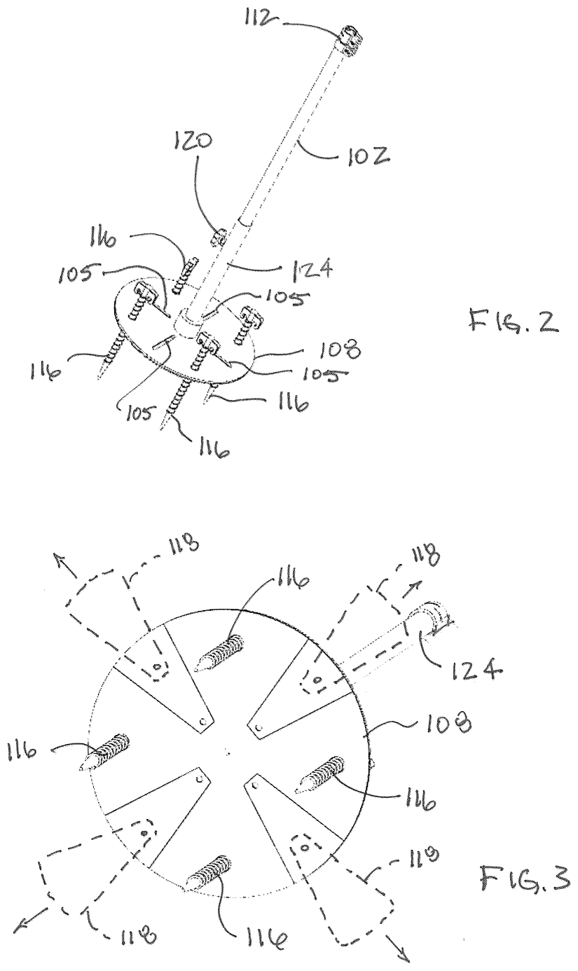

Referring now to FIG. 2, the threaded anchors 116 have a converging tip that is conducive for inserting into a ground surface. Each of the threaded anchors 116 may have external threading configured to cooperate with a plurality of apertures within the base 108 so that rotating a respective threaded anchor in a first direction causes the respective threaded anchor to move downward relative to the base 108. Likewise, rotating the respective threaded anchor 116 in an opposing second direction causes the respective threaded anchor to move upward relative to the base 108. The plurality of threaded anchors 116 in FIG. 2 are shown in a downward position relative to the base 108.

As described above, the base 108 includes a plurality of extensions 118 as shown in FIG. 3. The extensions 118 have a generally triangular shape so that a width of each extension is greater or increased at an exterior or outer portion compared to an interior portion. Accordingly, the shape of the plurality of extensions 118 increases the stability of the base 108 when the plurality of extensions 118 are deployed.

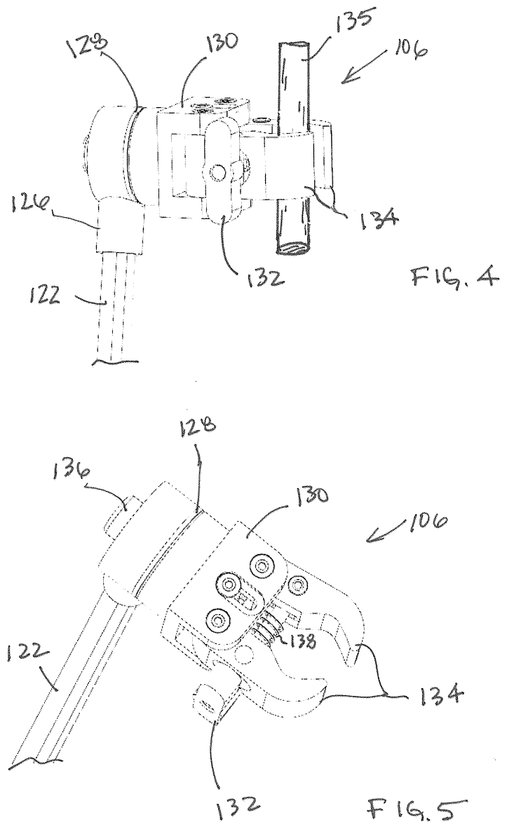

Referring now to FIG. 4, a detail view of the adjustable clamp 106 is depicted. The adjustable clamp 106 includes a rotatable coupling 128 that is configured to rotate relative to the telescoping member 122. The adjustable clamp 106 also includes a bracket 130 that is secured to the rotatable coupling 128. The bracket 130 has a pair of opposing jaws 134 extending outward. The jaws 134 are configured to grasp an umbrella shaft 135 and hold the umbrella securely. The bracket 130 also includes a rotatable handle 132 that is secured to a pin passing through the pair of opposing jaws 134.

As shown in FIGS. 5 and 6, the pair of opposing jaws 134 may be spring-loaded and biased in an open position. Accordingly, by being spring-loaded the jaws 134 create a space for the umbrella shaft 135 to slide between as the handle 132 is rotated to close the jaws 134 and grip the umbrella shaft 135. The rotatable coupling 128 has a button 136 that when depressed allows the user to rotate the adjustable clamp 106 to the desired position. When the button 136 is released, the rotatable coupling locks in place.

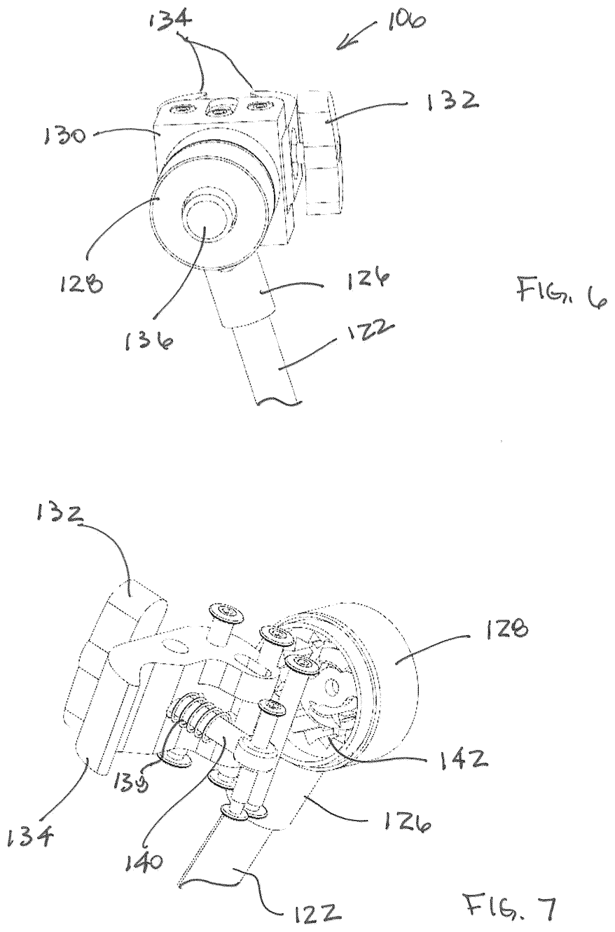

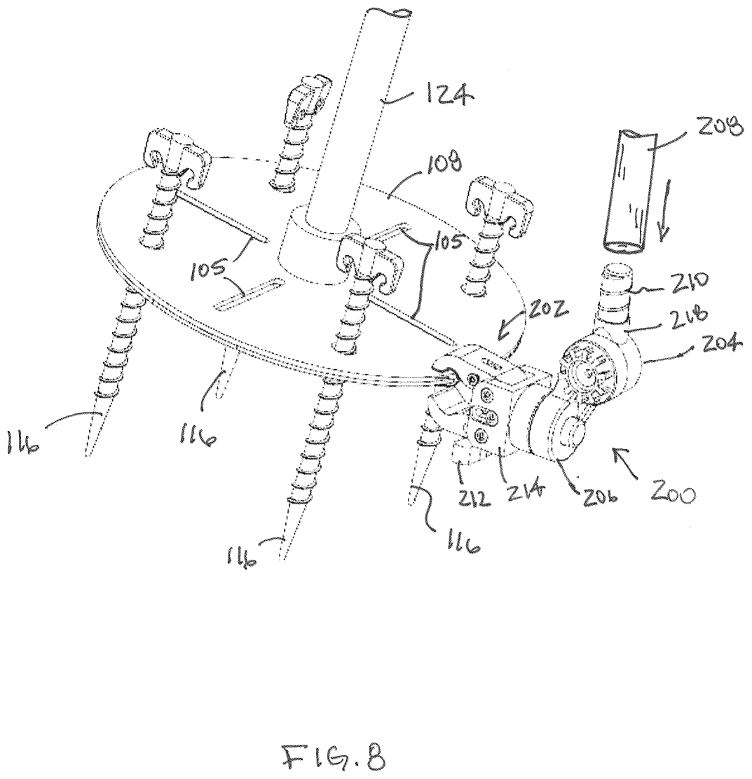

Components of the rotatable coupling 128 have been removed in FIG. 7 for clarity. Inside the rotatable coupling 128 are teeth 142 that are positioned on an inner perimeter of the rotatable coupling 128. Accordingly, as the button 136 is depressed the teeth 142 disengage allowing the bracket 130 to rotate relative to the telescoping member 122. The pin 140 and spring 138 that biases the pair of opposing jaws 134 in the open position is also visible in FIG. 7 with one of the jaws removed.

Referring now to FIG. 8, another aspect of the portable umbrella stand is depicted and generally designated 200. In particular, the portable umbrella stand 200 is configured for use without the base 108. In this aspect, the portable umbrella stand 200 includes a bracket 214 having a pair of opposing jaws 202 extending from a proximal end and configured to grasp an independent support such as a stroller, deck railings, deck chairs, wheelchairs, patio chairs, beach chairs, golf carts, push carts, or boat rails, for example. Accordingly, this aspect of the portable umbrella stand 200 expands the uses of the portable umbrella stand 100 discussed above to areas where the base 108 cannot be used.

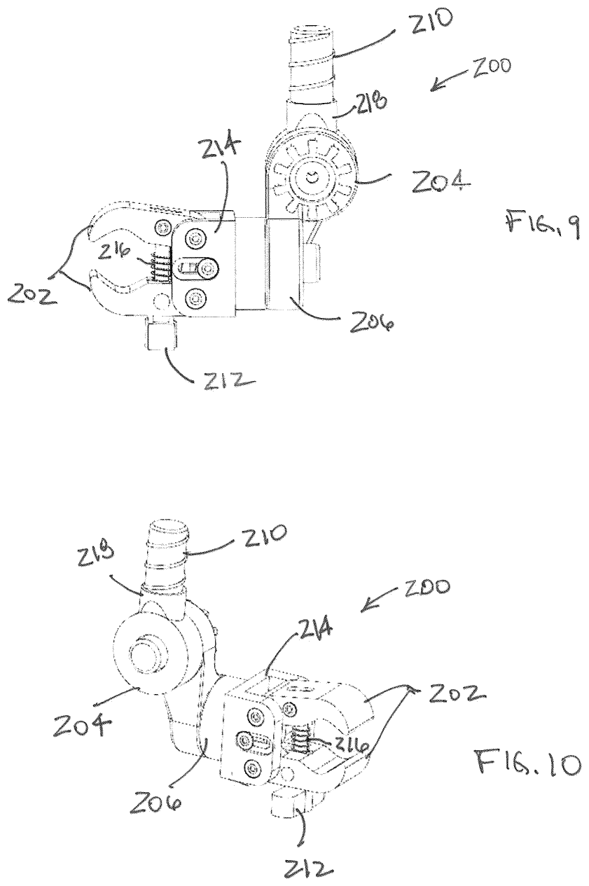

This aspect of the portable umbrella stand 200 comprises a first rotatable coupling 206 secured to a distal end of the bracket 214 as shown in FIGS. 9 and 10 and configured to rotate about a first axis. A second rotatable coupling 204 is secured to the first rotatable coupling 206 and configured to rotate about a second axis perpendicular to the first axis. A receiver 218 extends from the second rotatable coupling 204 and is configured to receive an umbrella shaft. The receiver 210 defines a cavity for receiving the shaft of the umbrella. Also, an extension 210 may be inserted into the receiver 218 for the shaft of the umbrella to slide over or vice versa. In addition, the extension 210 may be threaded in order to firmly secure the umbrella shaft thereto.

The bracket 214 may include a rotatable handle 212 secured to a pin 216 passing through the pair of opposing jaws 202. The handle 212 is configured to be rotated by the user to move the pair of opposing jaws 202 between an open position to a closed position to securely grasp the umbrella shaft. The pair of opposing jaws 202 are spring-loaded and biased in an open position.

In another aspect, a method of securing an umbrella to the portable umbrella stand 100 described above is disclosed. The method includes deploying the plurality of extensions 118 outwards along the plurality of slots 105 beyond a perimeter of the base 108 and securing the shaft of an umbrella 124 in the adjustable clamp 106. The method includes using the adjustable clamp 106 having a pair of opposing jaws 134 to grasp the shaft of the umbrella 124. In addition, the method includes rotating the plurality of threaded anchors 116 extending from the base 108 to cause the plurality of threaded anchors 116 to move downward relative to the base 108 to secure the base 108 to a ground surface.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A portable umbrella stand comprising:
a base having a plurality of slots spaced apart on the base;
a plurality of extensions slidingly engaged with the plurality of slots and configured to be deployed outwards along the plurality of slots beyond a perimeter of the base;
a plurality of threaded anchors removably coupled to the base;
a stanchion having a lower end and an upper end, the lower end coupled to the base and the upper end extending away from the base; and
a telescoping member having a lower end and an upper end, the lower end removably coupled to the upper end of the stanchion.

2. The portable umbrella stand of claim 1, further comprising an adjustable clamp secured to the upper end of the telescoping member.

3. The portable umbrella stand of claim 2, wherein the adjustable clamp having a rotatable coupling configured to rotate relative to the telescoping member.

4. The portable umbrella stand of claim 3, wherein the adjustable clamp comprises a bracket secured to the rotatable coupling and the bracket having a pair of opposing jaws extending therefrom and configured to grasp an umbrella shaft.

5. The portable umbrella stand of claim 4, wherein the pair of opposing jaws are spring-loaded and biased in an open position.

6. The portable umbrella stand of claim 5, wherein the bracket includes a rotatable handle secured to a pin passing through the pair of opposing jaws and the rotatable handle is configured to move the pair of opposing jaws between a closed position and the open position.

7. The portable umbrella stand of claim 1, wherein the telescoping member comprises a plurality of elongated extensions.

8. The portable umbrella stand of claim 1, wherein each threaded anchor of the plurality of threaded anchors comprises external threading configured to cooperate with a plurality of apertures within the base so that rotating a respective threaded anchor in a first direction causes the respective threaded anchor to move downward relative to the base, and rotating the respective threaded anchor in an opposing second direction causes the respective threaded anchor to move upward relative to the base.

9. The portable umbrella stand of claim 1, wherein the plurality of extensions increase in width from an interior portion to an outer portion to increase stability of the base when the plurality of extensions are deployed.

10. A portable umbrella stand comprising:
a bracket having a pair of opposing jaws extending from a proximal end and configured to grasp an independent support;
a first rotatable coupling secured to a distal end of the bracket and configured to rotate about a first axis;
a second rotatable coupling secured to the first rotatable coupling and configured to rotate about a second axis perpendicular to the first axis; and
a receiver extending from the second rotatable coupling and configured to receive a shaft of an umbrella.

11. The portable umbrella stand of claim 10, wherein the bracket includes a rotatable handle secured to a pin passing through the pair of opposing jaws and the rotatable handle is configured to move the pair of opposing jaws between a closed position and the open position.

12. The portable umbrella stand of claim 10, wherein the pair of opposing jaws are spring-loaded and biased in an open position.

13. The portable umbrella stand of claim 12, wherein the pin having a handle configured for a user to rotate to move the pair of opposing jaws between the open position and the closed position.

14. The portable umbrella stand of claim 13, further comprising an extension extending from the receiver configured for the shaft of the umbrella to slide over.

15. The portable umbrella stand of claim 14, wherein the extension is threaded.

16. The portable umbrella stand of claim 10, wherein the receiver defines a cavity for receiving the shaft of the umbrella.

17. A method of securing an umbrella to a portable umbrella stand comprising a base having a plurality of slots spaced apart on the base, a plurality of extensions slidingly engaged with the plurality of slots, a plurality of threaded anchors removably coupled to the base, a stanchion having a lower end coupled to the base, a telescoping member removably coupled to an upper end of the stanchion, and an adjustable clamp secured to an upper end of the telescoping member, the method comprising:
deploying the plurality of extensions outwards along the plurality of slots beyond a perimeter of the base; and
securing a shaft of an umbrella in the adjustable clamp.

18. The method of claim 17, further comprising using the adjustable clamp having a pair of opposing jaws extending therefrom to grasp the shaft of the umbrella.

19. The method of claim 18, wherein the pair of opposing jaws are spring-loaded and biased in an open position.

20. The method of claim 19, further comprising rotating a plurality of threaded anchors extending from the base to cause the plurality of threaded anchors to move downward relative to the base and to secure the base to a ground surface.
